(19) United States
(12) Patent Application Publication
(10) Pub. No.: US 2026/0161470 A1
(43) Pub. Date: Jun. 11, 2026

(54) RESOURCE ALLOCATION METHOD AND APPARATUS, AND ELECTRONIC DEVICE

(71) Applicant: Smarter Silicon (Shanghai) Technologies Co., Ltd., Shanghai (CN)

(72) Inventors: Neng KOU, Shanghai (CN); Zhongsong LIN, Shanghai (CN)

(21) Appl. No.: 19/406,034

(22) Filed: Dec. 2, 2025

(30) Foreign Application Priority Data
Dec. 9, 2024 (CN) 202411803238.8

(51) Int. Cl. G06F 9/50

(52) U.S. Cl. CPC G06F 9/5038; G06F 9/5016; G06F 9/5033

(57) ABSTRACT

A resource allocation method includes obtaining, in response to a resource access request of a target process in an electronic device, a target partition identifier corresponding to the target process, and assigning a target resource partition for the target process based on the target partition identifier. The target partition identifier is assigned to the target process in response to a target event occurring in one process, and the target event is related to changes in a resource allocation priority of the one process. The target resource partition is one of a plurality of resource partitions of a cache.

### CROSS-REFERENCE TO RELATED APPLICATION

This application claims priority to Chinese Patent Application No. 202411803238.8, filed on Dec. 9, 2024, the entire content of which is incorporated herein by reference.

### TECHNICAL FIELD

The present disclosure generally relates to the data processing field and, more particularly, to a method for allocating resources and an electronic device.

### BACKGROUND

Currently, electronic device processing systems add a high-speed cache memory (or simply cache) between the processor and memory. By setting up a cache, the speed difference between the processor and memory can be compensated. That is, the information that the processor needs is loaded into the cache, so that the processor can directly obtain information from the cache, thereby improving the allocate speed.

However, for smart terminals, which are electronic devices that are highly interactive with users, different types of application processes on these devices are prone to resource contention and reduced hit rates when allocating cache resources.

### SUMMARY

In accordance with the disclosure, there is provided a resource allocation method including obtaining, in response to a resource access request of a target process in an electronic device, a target partition identifier corresponding to the target process, and assigning a target resource partition for the target process based on the target partition identifier. The target partition identifier is assigned to the target process in response to a target event occurring in one process, and the target event is related to changes in a resource allocation priority of the one process. The target resource partition is one of a plurality of resource partitions of a cache.

Also in accordance with the disclosure, there is provided an electronic device including a cache including at least one resource partition and an allocation component configured to obtain, in response to a resource access request of a target process in the electronic device, a target partition identifier corresponding to the target process, and assign a target resource partition for the target process based on the target partition identifier. The target partition identifier is assigned to the target process in response to a target event occurring in one process, and the target event is related to changes in a resource allocation priority of the one process. The target resource partition is one of the at least one resource partition.

Also in accordance with the disclosure, there is provided a non-transitory computer-readable storage medium storing instructions that, when executed by a processor, cause an electronic device including the processor to obtain, in response to a resource access request of a target process in the electronic device, a target partition identifier corresponding to the target process, and assign a target resource partition for the target process based on the target partition identifier. The target partition identifier is assigned to the target process in response to a target event occurring in one process, and the target event is related to changes in a resource allocation priority of the one process. The target resource partition is one of a plurality of resource partitions of a cache.

### BRIEF DESCRIPTION OF THE DRAWINGS

To more clearly illustrate the technical solutions in the embodiments of the present disclosure, the drawings used in the description of the embodiments will be briefly introduced below. Obviously, the drawings described below are merely some embodiments of the present disclosure. For those skilled in the art, other drawings can be obtained based on the present disclosure without creative effort.

FIG. 1 is a flowchart of a resource allocation method consistent with the present disclosure.

FIG. 2 is a schematic diagram showing an information format of a resource configuration policy consistent with the present disclosure.

FIG. 3 is a flowchart of a resource allocation method based on process grouping update events consistent with the present disclosure.

FIG. 4 is a flowchart of a partition identifier update method consistent with the present disclosure.

FIG. 5 is a schematic diagram showing a resource processing module of an electronic device consistent with the present disclosure.

FIG. 6 is a schematic flowchart of an initialization process consistent with the present disclosure.

FIG. 7 is a flowchart showing dynamically assigning partition identifiers to processes consistent with the present disclosure.

FIG. 8 is a schematic structural diagram of a resource allocation device consistent with the present disclosure.

### DETAILED DESCRIPTION OF THE EMBODIMENTS

The technical solutions in the embodiments of the present disclosure will be clearly and completely described below with reference to the accompanying drawings. Obviously, the described embodiments are only some embodiments of the present disclosure, and not all embodiments. Based on the embodiments of present disclosure, all other embodiments obtained by those skilled in the art without inventive effort are within the scope of the present disclosure.

The terms “first,” “second,” etc., in the embodiments of the present disclosure are used to distinguish similar objects and are not necessarily used to describe a specific order or sequence. Furthermore, the terms “comprising” and “having,” and any variations thereof, are intended to cover non-exclusive inclusion. For example, a process, method, system, product, or device that includes a series of or units is not necessarily limited to those or units explicitly listed, but may include other or units not explicitly listed or inherent to these processes, methods, products, or devices.

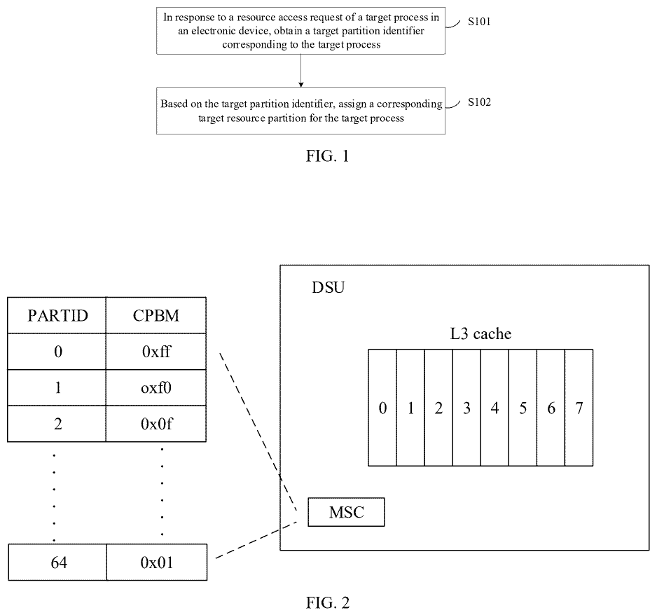

The present disclosure provides a resource allocation method applied to application scenarios involving allocating cache resources corresponding to electronic devices. The electronic device can be various types of devices with information processing functions, such as smartphones, tablets, wearable devices, portable computers, all-in-one computers, desktop computers, vehicle terminals, servers, and server clusters. The electronic device may include various storage modules, such as memory, cache, and external storage modules. Adding a cache (high-speed cache memory, cache) between the CPU (central processing unit) and memory of the electronic device can reduce data allocation time and improve system performance. In computer systems, caches are typically divided into multiple levels, from CPU cache (such as L1, L2, and L3 caches) to main memory (RAM) and then to disk cache. The embodiments of present disclosure enable efficient access of cache resources, improving system processing performance A resource allocation method is shown in FIG. 1, which includes the following.

At S101, in response to a resource access request of a target process in an electronic device, a target partition identifier corresponding to the target process is obtained.

At S102, based on the target partition identifier, a corresponding target resource partition for the target process is assigned.

An electronic device executes multiple processes during its operation. A process is the execution flow of a program over a data set within the electronic device, and it is the unit for resource assignment and allocation by the system and represents a running instance of a program. The process in the electronic device that currently needs to access cache resources is identified as the target process, that is, the resource access request is a cache resource access request. A resource configuration policy executed by the electronic device includes the mapping between partition identifiers and resource partitions. A resource partition refers to a allocated space within the cache. For example, partition identifiers include 01, 02, and 03.

Correspondingly, partition identifier 01, partition identifier 02, and partition identifier 03 can correspond to resource partition 001, resource partition 002 and resource partition 003 respectively, and so on. The mapping between partition identifiers and resource partitions can be configured during cache system initialization.

The target partition identifier corresponding to the target process is the identifier information assigned to the target process when a target event occurs. The target event is related to changes in the resource allocation priority of a process, and is also referred to as a “target process-event.” For example, the target event can be a switching event of the current process's response priority. In some embodiments, the target event can be an application switching event in an electronic device. When an electronic device switches from running a first application to a second application, the response priority of the second application will be higher than that of the first application. Furthermore, the response priority of each process corresponding to the second application will be higher than that of each process corresponding to the first application. Therefore, when the application running in an electronic device is switched, a process response priority switching event is triggered, which can then trigger an update of the target process's partition identifier. In the present disclosure, the target partition identifier corresponding to the target process is the partition identifier currently allocated for the target process. The cache resources of the target resource partition corresponding to this target partition identifier can satisfy the resource access requests of the target process, and the cache resources of the target resource partition can further satisfy the response needs of the target process.

After the target resource partition corresponding to the target partition identifier is obtained, the target process is assigned to this target resource partition, enabling the target process to call the cache resources in the target resource partition. Consistent with the present disclosure, the pre-stored mapping between partition identifiers and resource partitions in the electronic device is pre-configured. Each resource partition can correspond to a cache resource with different characteristics, which allows the cache resources corresponding to each partition identifier to be different. In some embodiments, the resource partitions corresponding to each partition identifier can all be resource partitions with different characteristics. For example, the resource storage capacity of the resource partitions corresponding to each partition identifier can be different, or some of the resource partitions corresponding to each partition identifier can be the same, while others are different. In another embodiment, each resource partition can be divided into different levels according to its characteristics, and each level can have one or more resource partitions. For example, the storage capacity range of resource partitions corresponding to different levels can be different. In some embodiments, the storage capacity of each resource partition at first level is greater than that at second level. The characteristics of each resource partition can be pre-configured according to actual needs, and the mapping between partition identifier and each resource partition can be further configured.

The mapping between processes and partition identifiers in electronic devices is not fixed. After a resource access request from a target process is received, a current target partition identifier corresponding to that target process is determined, allowing the target process to be assigned to the most matching target resource partition. For example, the target event can be an application switching event in an electronic device. When the target process is running the first application on the electronic device, the target process can be a background process and corresponds to a first partition identifier. When the electronic device switches to the second application, the target process can be a foreground process, and the partition identifier of the target process can be determined as a second partition identifier. A second resource partition corresponding to the second partition identifier has more accessible cache resources than a first resource partition corresponding to the first partition identifier, the cache resource access needs of the target process as a foreground process can be satisfied. In this way, the process resource allocation needs and system response performance can be improved. Consistent with the present disclosure, the information included in the cache resource can be determined based on the attribute information corresponding to the cache resource, and the cache resource may include: storage space size, cache granularity, and cache data synchronization configuration mechanism. For example, cache space is typically assigned in units of portion (portion can be a unit data block within the cache space). A cache partition with more cache resources includes more cache data portions.

The resource allocation method of present disclosure is described below with reference to actual application scenarios.

In some embodiments of the present disclosure, assigning a corresponding target resource partition to a target process based on a target partition identifier includes determining the target partition identifier corresponding to the target process, assigning a corresponding target resource partition to the target process according to the resource configuration policy corresponding to the target partition identifier.

The resource configuration policy includes the mapping between partition identifiers and resource partitions. The target partition identifier is one of the partition identifiers, meaning that the cache resources in the target resource partition corresponding to the target partition identifier can match the resource access needs of the target process. To quickly determine the resource partition that matches the process, a resource configuration policy can be pre-generated and stored in an electronic device, such as in the allocation component, of the electronic device, that executes the resource access method. This allows for the determination of target resource partitions based on the target partition identifier corresponding to the target process and the resource configuration policy, and the corresponding configuration of target resource partitions, such as bandwidth configuration and cache data reading configuration.

In some embodiments, during generation of the resource configuration policy, different resource partitions can be determined for different partition identifiers. For example, some resource partitions may have a larger number of cache resources, or the corresponding cache resources may have stronger real-time update synchronization characteristics, thus meeting different cache resource access needs. FIG. 2 is a schematic diagram showing the information format of a resource configuration policy, in which PARTID represents the partition identifier, and CPBM represents the cache policy. The corresponding resource partition locations in the caching policy are listed in FIG. 2, and the corresponding resource partitions are identified in hexadecimal encoding. The resource partition can correspond to multiple resource portions in the L3 cache (i.e., shared cache) corresponding to the DSU, e.g., the resource portion corresponding to the corresponding partition identifier can be determined through this resource configuration policy. DSU is part of ARM DynamIQ technology, and it is a CPU cluster design that allows different types and numbers of CPU cores (including large cores and small cores) to be combined to share resources and communication. The mapping between partition identifiers and resource partitions can be stored as configuration file in the corresponding area, so that when resources are accessed, the resource partition corresponding to the current partition identifier can be obtained based on the configuration file. For example, this configuration file can be an embedded management unit file (MSC file). To meet the resource access needs of different processes, some partition identifiers can be configured with a larger number of resource portions, while others can have a smaller number. Thus, if a foreground process has high responsive needs, the foreground process can be assigned to a partition identifier with a larger number of resource portions to meet resource access needs of the foreground process. In this way, the foreground process can respond to user operations promptly to improve user experience.

To meet real-time cache resource access needs of corresponding processes, the mapping between processes and partition identifiers in the present disclosure is not fixed but updated according to changes in resource allocation priority. In some embodiments, in response to a target event occurring in a process, the corresponding partition identifier is updated for the process, and the target resource partition of the process is dynamically adjusted to meet performance needs.

The target event is related to changes in resource allocation priority of the process. For example, the target event could be an event of switching the currently running application in the electronic device, or a user-triggered operation event. Correspondingly, the target event can occur during the configuration or adjustment of a process.

Monitoring of switching events can be achieved by capturing key system signals, for example, by combing with the updated information of general process groups, i.e., the update of process groups, to determine the generation a target event has occurred. Thus, consistent with the present disclosure, the monitoring process of the target event can be combined with the update event of process groups, making implementation technically easier. Further, utilizing general process group assignment information makes it easier to distinguish different processes and reuse of existing technologies, thereby improving the efficiency of resource allocation process.

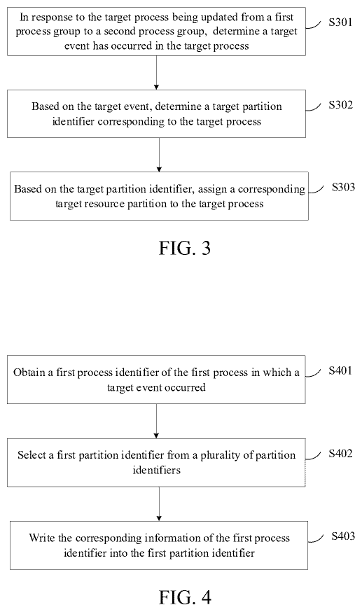

In some embodiments, a flowchart of a resource allocation method based on process grouping update events is shown in FIG. 3, the method includes the following.

At S301, in response to the target process being updated from a first process group to a second process group, it is determined that a target event has occurred in the target process.

At S302, based on the target event, a target partition identifier corresponding to the target process is determined.

At S303, based on the target partition identifier, a corresponding target resource partition is assigned to the target process.

To facilitate process response and management, processes can be grouped. For example, in an operating system, process grouping allows for the assignment of different resource limits to processes in different groups, such as the usage of CPU time, memory or other storage resource, and I/O bandwidth, etc. Processes can be grouped according to priority to ensure that high-priority processes get more resources and faster responses. Different process groups can correspond to different partition identifiers and different resource partitions. The processes in each process group are not fixed. The processes in each process group are updated based on the operating status, response method of the electronic device, and the influence of the currently running applications. When a process group update is detected, a corresponding target event occurs, and the partition identifier corresponding to the process will be updated. For example, in one process monitoring period, the target process was a background process and belonged to a first process group. The first process group corresponds to a first partition identifier, and the target process corresponds to the first partition identifier. When the response status of an application in the electronic device changes, the corresponding process group is updated. If the target process is a foreground process, the target process can be updated to be in a second process group corresponding to the foreground process. The second process group corresponds to a second partition identifier, and the target partition identifier corresponding to the target process is the second partition identifier, and the target process can allocate cache resources of the second resource partition corresponding to the second partition identifier. This allows processes in the electronic device to match optimal cache resources in real time, meeting the cache resource access needs of the process and improving response efficiency.

Consistent with the present disclosure, the general Control Groups (CGroup) technology for process management can be used to isolate physical resources of the processes, reducing interference between processes and improving system response speed and stability. For example, CGroup technology can be used to group processes. Foreground processes can be assigned to corresponding foreground process group, and background processes can be assigned to corresponding background process group. Furthermore, CGroup technology can be used to dynamically adjust process-related information, for example, dynamically change the information of each process in the process group. Based on the current operating status of the electronic device, corresponding processes can be added to relevant process groups, or processes in relevant process groups can be adjusted. If the current application is switched, some processes in the background process group can be moved to the foreground process group.

Correspondingly, the allocation component executing the resource allocation method can be data-connected with the component executing CGroup process group assignment information.

Thus, the allocation component can obtain relevant update information about process groups and determine whether to adjust the partition identifier of the corresponding process based on the update information. This facilitates the reuse of existing technologies, making implementation more convenient and resource access more efficient.

Furthermore, the embodiment of the present disclosure also provides a partition identifier update method. This method is used to update the corresponding partition identifier for a process in response to a target event occurring in the process. As is shown in FIG. 4, the method includes the following.

At S401, a first process identifier of the first process in which a target event occurred is obtained.

At S402, a first partition identifier is selected from a plurality of partition identifiers.

At S403, the corresponding information of the first process identifier is written into the first partition identifier.

The resource configuration policy corresponding to the first partition identifier corresponds to the resource allocation priority of the first process. The first process in which a target event occurred can be a process that generated the target event, such as a newly started process. Correspondingly, the first process can also be a process affected by the target event, for example, the target event can be a user of an electronic device launching an audio application, the corresponding audio-related process is the first process. Then, the first process can be parsed to determine corresponding process characteristic information of the first process. The process characteristic information may include response needs, frequency of resource accesses, amount of cache resources allocated, and the number of threads of the process. Based on the first process characteristic information, a first partition identifier matching the first process is determined. During the process of determining the first partition identifier, the resource configuration policy corresponding to the partition identifier can also be obtained. The first partition identifier corresponding to the first process is determined based on the mapping between the resource configuration policy and resource allocation priorities. Correspondingly, after determining the first process in which the target event occurred, first grouping information, including the identifier of the first process, can be determined. A suitable partition identifier, i.e., the first partition identifier, is then obtained based on the first grouping information. Process grouping is typically implemented using CGroup technology. CGroup technology is used for CPU (Central Processing Unit) resource control and already considers process priorities when grouping processes. Therefore, a mapping between partition identifiers and corresponding CGroup grouping information can be established in advance. After a process is updated into a process group, a matching partition identifier is assigned to the process. Based on the CGroup grouping, management is easier to implement utilizing existing system. Further, the cache resources and CPU resource control subsequently assigned to processes in this group are matched, so that the resource assignment is more accurate, and the later process is more efficient.

The resource configuration policy includes a mapping between partition identifiers and resource partitions. The resource partitions that meet the resource allocation priority of the first process can be determined by the resource configuration policy, and the partition identifier corresponding to that resource partition can be determined as the first partition identifier. For example, if the first process needs to allocate cache resources frequently, the resource allocation priority of the first process is high. The partition identifier corresponding to a resource partition with high response efficiency can be determined as the first partition identifier to improve the efficiency of cache resource access. After determining the first partition identifier, the first process identifier is written into the first partition identifier to assign the partition identifier to the first process, and the cache resource access needs of the first process can be met based on the first partition identifier. The first process identifier can represent the process information, such as thread information and configuration information, of the first process.

Further, consistent with the present disclosure, writing the corresponding information of the first process identifier into the first partition identifier includes parsing the first process identifier to obtain each first thread identifier corresponding to the first process, and writing all the first thread identifiers corresponding to the first process into the first partition identifier.

During the operation of an electronic device, a thread is an instance of a process, a unit of CPU access and execution, and an independently executable basic unit smaller than a process. Threads depend on processes and are scheduled by the operating system. Therefore, it is needed to parse the first process identifier to obtain each first thread identifier corresponding to the first process, and then write all the first thread identifiers into the first partition identifier. This way, when executing each first thread corresponding to the first process, the cache resources of the corresponding target resource partition can be obtained based on the first partition identifier, ensuring the accuracy of cache resource access and resource response efficiency.

Consistent with the present disclosure, in determination of the mapping between each partition identifier and the resource partition, different resource partitions can be configured to meet different resource access needs. In some embodiments, the plurality of partition identifiers are configured with different resource assignment policies, and the resource assignment policy includes the following. resource partitions corresponding to the partition identifiers. The plurality of partition identifiers include at least two types of partition identifiers, and the two types of partition identifiers correspond to at least two resource assignment policies with different resource access priorities.

Consistent with the present disclosure, the resource assignment policy includes a resource partition corresponding to the partition identifier, that is, the resource assignment policy can guarantee which resource partition will be assigned to the corresponding partition identifier. To meet the resource access needs of different processes, the plurality of partition identifiers can be divided into at least two types, such as a first-type partition identifier and a second-type partition identifier. Different types of partition identifiers correspond to different resource assignment policies of resource access priorities. For example, the first-type partition identifier corresponds to a resource assignment policy with higher resource access priority, and the second-type partition identifier corresponds to a resource assignment policy with lower resource access priority. The resource assignment policy with higher resource access priority can assign the corresponding partition identifier to a resource partition with first-level cache resource characteristics. The cache resource characteristics can be partition size, resource quantity, resource update frequency, and resource response efficiency of the corresponding resource partition. Taking partition size as an example, a resource partition with first-level cache resource characteristic can be a resource partition with a larger resource partition size. Correspondingly, a resource assignment policy with lower priority can assign the corresponding partition identifier to a resource partition with second-level cache resource characteristics. A resource partition with second-level cache resource characteristics can be a resource partition with a smaller corresponding resource partition size. For example, the first type of partition identifier can be the partition identifier corresponding to the foreground process, which can correspond to a resource partition with more cache resource portions; the second type of partition identifier can be the partition identifier corresponding to the background process, which can correspond to a resource partition with a relatively smaller number of cache resource portions. This allows for more cache resources to be configured for the foreground process, reducing cache resource misses in the foreground process, responding to user operations promptly when interacting with users, thereby improving the user experience.

The above method can be implemented at the operating system level of the electronic device, through the interaction between the operating system and the underlying cache management module.

Taking a Linux electronic device with Android operating system as an example, in order to allocate cache resources more efficiently, the resource allocation method can be executed through an allocation component of the electronic device. The allocation component is determined based on the characteristics of the current electronic device. For example, the allocation component can be the MPAM (Memory System Resource Partitioning and Monitoring) module provided by the ARM architecture. MPAM is used for memory system resource partitioning and monitoring and is capable of memory system partitioning. Thus, MPAM can be used to control the use of corresponding cache resources by processes in the electronic device.

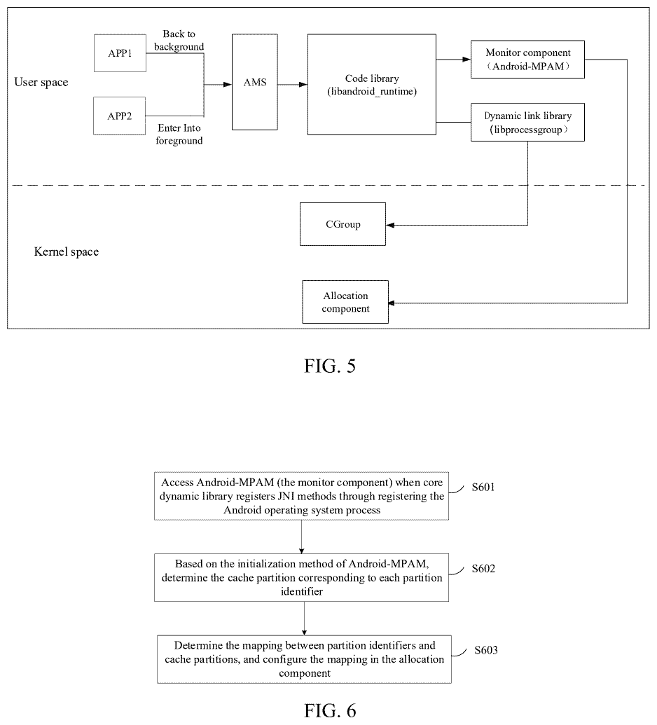

FIG. 5 is a schematic diagram showing a resource processing module of an electronic device according to an embodiment of the present disclosure. As shown in FIG. 5, in the operating system of an electronic device, user space and kernel space are two main system layers. User space is the environment in the operating system for application programs to run. In this user space, applications can only access limited resources and are managed by the operating system. Kernel space is the core part of the operating system. Kernel space has direct control over the hardware and is responsible for managing system resources, including CPU, memory, disk, and I/O devices.

Resource configuration policies can also be pre-generated before executing tasks, that is, the mapping between each partition identifier and the corresponding resource partition can be pre-generated. FIG. 6 is a schematic flowchart of an initialization process according to an embodiment of the present disclosure. This initialization process corresponds to the pre-configuration of the mapping between each partition identifier and resource partition. In some embodiments, the initialization process includes the following.

At S601, when core dynamic library registers JNI methods through registering the Android operating system process, Android-MPAM (the monitor component) is called.

When libandroid_runtime (a core dynamic library in the Android system that provides multiple functions and interfaces enabling applications to interact with the Android system's underlying layer) registers JNI methods through register_android_os_Process (registering the Android operating system process), the initialization method of Android-MPAM (Android system memory system resource allocation and monitoring module, referred to as the monitor component) is called for initialization. libandroid_runtime provides an interface for interaction between the Java layer and the Native layer (C/C++ code) through the Java Native Interface (JNI). JNI allows Java code to call native library functions and, conversely, to call Java methods from native code.

At S602, based on the initialization method of Android-MPAM, the cache partition corresponding to each partition identifier is determined.

The configuration principle of initialization method of Android-MPAM is allocating more cache resources for foreground processes than background processes. In some embodiments, the cache space can be divided into multiple cache partitions. The cache space can be divided into multiple cache partitions based on data cache portions, with each cache partition containing a different number of data cache portions. For example, the first-level cache partition may have more data cache portions than the second-level cache partition. As another example, the cache partition corresponding to the partition identifier of the foreground process can have more data cache portions than the cache partition corresponding to the partition identifier of the background process.

At S603, the mapping between partition identifiers and cache partitions is determined and configured in the allocation component.

The allocation component executes resource allocation methods to assign corresponding cache partitions to processes. Typically, the mapping between partition identifiers and resource partitions is determined based on the priority of resource access. For example, the foreground process will have more resource portions configured than the background process, that is, the partition identifier corresponding to the foreground process will be matched with a resource partition with more resources, and the partition identifier corresponding to the background process will be matched with a resource partition with fewer resources. Taking the cache resources corresponding to DSU as an example, the shared cache partition L3 can be divided into multiple resource portions. Further, the allocation component MPAM is capable of allocating resource partitions corresponding to a plurality of partition identifiers. Each partition identifier uses the resource portions of the corresponding resource partition according to the mapping between the resource partition and the resource partition included in the resource configuration policy. Since the foreground process has more resource portions configured in the resource partitions, the problem of cache resource misses in the foreground process can be reduced. This allows for responding to user operations promptly when interacting with users, thereby improving the user experience.

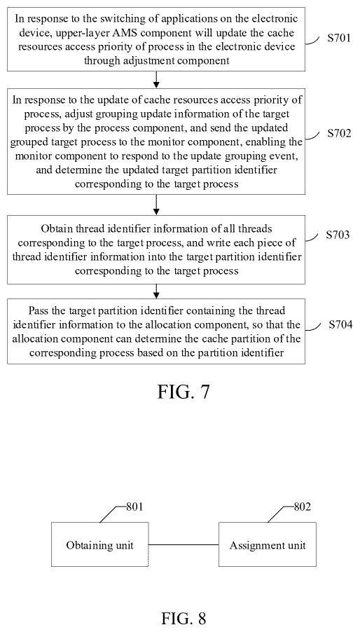

FIG. 7 is a flowchart showing dynamic assignment of partition identifiers for processes according to the embodiment of the present disclosure. The process includes the following.

At S701, in response to the switching of applications on the electronic device, the cache resources access priority of process in the electronic device will be updated by upper-layer AMS component through adjustment component.

The applications interacting with the users will be monitored in the user space. When an application switch is detected, for example, the current user starts application 2 (represented by APP2) and closes application 1 (represented by APP1), this means an application switch event occurred, causing APP1 returned back to the background and APP2 entered into the foreground. At this time, the upper-layer AMS component will update the process priority of the electronic device through adjustment component. The AMS component can be a system server in the Android system that interacts with upper-layer applications. The AMS component is responsible for starting, switching, and allocating related components within the Android system, as well as managing and allocating application processes. The adjustment component can be a component within the Android system, for example, the OoM Adjuster component, which dynamically adjusts the memory usage priority of a process based on process priority and memory usage. Consistent with the present disclosure, the adjustment component can adjust the cache resources access priority of process in response to application switching. For example, after detecting APP2 entered foreground, the process corresponding to APP2 can be determined as a foreground process, thereby adjusting the corresponding cache resource access priority to a higher priority, i.e., prioritizing the cache resources allocation.

At S702, in response to the update of cache resources access priority of process, grouping update information of the target process is adjusted by a process component, and the updated grouped target process is sent to the monitor component, enabling the monitor component to respond to the update grouping event, and the updated target partition identifier corresponding to the target process can be determined.

The target process is the process in which resource allocation priority changes after the current application switching. After updating the cache resource access priority of a process in response to an application switch, the corresponding process grouping of the target process can be adjusted by corresponding processing, and the updated process group can be added to the code library, such as libandroid_runtime in the Android system (which is a core dynamic library in the Android system that contains the core code of the Android Runtime Environment (ART), including the class loader, virtual machine, JIT compiler, etc.). Then, the code library passes the updated process group to a dynamic link library (such as libprocessgroup), which is responsible for managing process groups. In some embodiments, the process component can be a functional component that performs process grouping changes, such as a component that performs CGroup function. CGroup can organize processes into tree-structured groups and apply specific resource limits and policies to each group. In the embodiments of the present disclosure, CGroup technology can be used to update the grouping of the target process, such as adjusting the target process from a background process group to a foreground process group, thereby determining the partition identifier corresponding to the target process that satisfies the foreground process resource access mode. While updating process group settings, monitor component (such as Android-MPAM) is also notified, the partition identifier corresponding to the target process after the group change will be passed to the allocation component. This allows the allocation component to determine the resource partition of the corresponding thread based on the partition identifier.

Consistent with the present disclosure, a monitor component (such as Android-MPAM) is added in user space. When the upper-layer AMS performs process grouping updates or switching, the monitor component can pass the updated partition identifier or related information of the corresponding target process to the allocation component (such as DSU/SLC MPAM), enabling the allocation component to accurately assign the corresponding cache resources and improve the efficiency and performance of processing of the system.

At S703, thread identifier information of all threads corresponding to the target process is obtained, and each piece of thread identifier information is written into the target partition identifier corresponding to the target process.

At S704, the target partition identifier containing the thread identifier information is passed to the allocation component, so that the allocation component determines the cache partition of the corresponding process based on the partition identifier.

For example, the thread identifiers (e.g., represented by TID) of all threads of the process corresponding to the target partition identifier are obtained, and the thread identifiers TID are written to the partition identifier of the allocation component MPAM in the kernel space cache. The cache can be a DSU (DynamIQ Shared Unit) cache. DSU is part of ARM DynamIQ technology, a new CPU cluster design that allows combining different types and numbers of CPU cores (including big and little cores) to share resources and communication. The cache can also be an SLC (System Level Cache) cache. SLC is a system-level cache that acts as the next-level cache for all connected CPUs, typically implemented in a memory interconnect based on the AMBA Coherent Hub Interconnect (CHI) protocol.

Taking the MPAM allocation component of DSU as an example, when the CPU needs to execute a task, the allocation component configures the resource configuration policy according to the partition identifier corresponding to the task in the CPU's registers. This way, during task execution, resource allocation by each thread of the process corresponding to the task can be restricted to the resource partition corresponding to the partition identifier in the resource configuration policy, achieving efficient cache resources access.

The embodiments of present disclosure also provide a resource allocation device in FIG. 8. The device includes following.

An obtaining unit 801, configured to obtain a target partition identifier corresponding to a target process in response to a resource access request from the target process of an electronic device.

An assignment unit 802, configured to assign a corresponding target resource partition to the target process based on the target partition identifier, in which the target resource partition is one of a plurality of cache resource partitions.

The target partition identifier is assigned to the target process when a target event occurs, and the target event is related to changes in the resource allocation priority of the process.

In some embodiments of the present disclosure, the assignment unit includes following.

A first determination subunit, configured to determine the target partition identifier corresponding to the target process.

A first assignment subunit, configured to assign a corresponding target resource partition to the target process according to a resource configuration policy corresponding to the target partition identifier, in which the resource configuration policy includes the mapping between partition identifiers and resource partitions, and the target partition identifier is one of the partition identifiers.

In some embodiments of the present disclosure, the device further includes following.

An update unit, configured to update the corresponding partition identifier for the process in response to a target event occurring.

In some embodiments of the present disclosure, the updating unit includes following.

A first obtaining subunit, configured to obtain a first process identifier of the first process in which the target event occurred.

A selection subunit, configured to select a first partition identifier from a plurality of partition identifiers, in which the resource configuration policy corresponding to the first partition identifier corresponds to the resource allocation priority of the first process.

A first writing subunit, configured to write the corresponding information of the first process identifier into the first partition identifier.

In some embodiments of the present disclosure, the first writing subunit is configured to: parse the first process identifier to obtain each first thread identifier corresponding to the first process; and write all the first thread identifiers corresponding to the first process into the first partition identifier.

In some embodiments of the present disclosure, each of the plurality of partition identifiers is configured with a different resource assignment policy, in which the resource assignment policy includes at least: resource partitions corresponding to the partition identifiers.

The plurality of partition identifiers include at least two types of partition identifiers, and the two types of partition identifiers correspond to at least two different resource assignment policies with different resource access priorities.

In some embodiments of the present disclosure, the device further includes following.

A target event determination unit, configured to determine that a target event has occurred in the target process in response to the target process being updated from a first process group to a second process group.

The reference can be made to above content for specific implementations of each unit and subunit in the present disclosure.

The present disclosure also provides a readable storage medium. The readable storage medium carries computer programs. When executed by a processor, the computer program implements the resource allocation method described in the present disclosure.

The present disclosure also provides an electronic device. The electronic device includes following.

A cache, the cache including at least one resource partition.

An allocation component, the allocation component being configured to: in response to a resource access request from a target process of the electronic device, obtain a target partition identifier corresponding to the target process; based on the target partition identifier, allocate corresponding target resource partition to the target process, the target resource partition being one of a plurality of resource partitions in the cache.

The target partition identifier is assigned to the target process when a target event occurs in the process, the target event being related to changes in the resource allocation priority of the process.

In some embodiments of the present disclosure, assigning a corresponding target resource partition to the target process based on the target partition identifier includes following.

Determining the target partition identifier corresponding to the target process.

According to the resource configuration policy corresponding to the target partition identifier, assigning a corresponding target resource partition to the target process, in which the resource configuration policy includes the mapping between partition identifiers and resource partitions, and the target partition identifier is one of the partition identifiers.

In some embodiments of the present disclosure, the method further includes updating the corresponding partition identifier for the process in response to a target event occurring in the process.

In some embodiments of the present disclosure, updating the corresponding partition identifier for the process in response to a target event occurring in the process includes the following.

Obtaining a first process identifier of the first process in which a target event occurred.

Selecting a first partition identifier from a plurality of partition identifiers, in which the resource configuration policy corresponding to the first partition identifier corresponds to the resource allocation priority of the first process.

Writing the corresponding information of the first process identifier into the first partition identifier.

In some embodiments of the present disclosure, writing the corresponding information of the first process identifier into the first partition identifier includes the following.

Parsing the first process identifier to obtain each first thread identifier corresponding to the first process.

Writing all the first thread identifiers corresponding to the first process into the first partition identifier.

In some embodiments of the present disclosure, the plurality of partition identifiers are configured with different resource assignment policies, the resource assignment policy including at least: a resource partition corresponding to a partition identifier.

The plurality of partition identifiers include at least two types of partition identifiers, and the two types of partition identifiers correspond to at least two different resource assignment policies with different resource access priorities.

In some embodiments of the present disclosure, the method further includes determining that a target event has occurred in the target process in response to the target process being updated from a first process group to a second process group.

In some embodiments of the present disclosure, the electronic device further includes a configuration module for storing resource configuration policies, the resource configuration policies including the mapping between partition identifiers and resource partitions.

Reference can be made to above disclosure for specific implementation of the allocation component in the present disclosure.

The various embodiments in this specification are described in a progressive manner, with each embodiment focusing on the differences from other embodiments. Similar or identical parts between embodiments can be referred to mutually. For the apparatus disclosed in the embodiments, since it corresponds to the method disclosed in the embodiments, the description is relatively simple, and relevant parts can be referred to the method section.

Those skilled in the art will further recognize that the units and algorithm of the various examples described in conjunction with the embodiments disclosed herein can be implemented in electronic hardware, computer software, or a combination of both. To clearly illustrate the interchangeability of hardware and software, the components and of the various examples have been generally described in terms of functionality in the foregoing description. Whether these functions are implemented in hardware or software depends on the specific application and design constraints of the technical solution. Those skilled in the art can implement the described functions using different methods for each specific application, but such implementation should not be considered beyond the scope of the present disclosure.

The of the methods or algorithms described in conjunction with the embodiments disclosed herein can be implemented directly in hardware, software modules executed by a processor, or a combination of both. Software modules can be located in random allocate memory (RAM), main memory, read-only memory (ROM), electrically programmable ROM, electrically erasable programmable ROM, registers, hard disks, removable disks, CD-ROMs, or any other form of storage medium known in the art.

The foregoing description of the disclosed embodiments enables those skilled in the art to implement or use the present disclosure. Various modifications to these embodiments will be readily apparent to those skilled in the art, and the general principles defined herein may be implemented in other embodiments without departing from the spirit or scope of the present disclosure. Therefore, the present disclosure is not to be limited to the embodiments shown herein, but is to be accorded the broadest scope consistent with the principles and features disclosed herein.

What is claimed is:

1. A resource allocation method comprising:
obtaining, in response to a resource access request of a target process in an electronic device, a target partition identifier corresponding to the target process, the target partition identifier being assigned to the target process in response to a target event occurring in one process, and the target event being related to changes in a resource allocation priority of the one process; and
assigning a target resource partition for the target process based on the target partition identifier, the target resource partition being one of a plurality of resource partitions of a cache.

2. The method according to claim 1, wherein assigning the target resource partition for the target process includes:
assigning the target resource partition for the target process according to a resource configuration policy corresponding to the target partition identifier, the resource configuration policy including a mapping between partition identifiers and resource partitions, and the target partition identifier being one of the partition identifiers.

3. The method according to claim 2, further comprising:
updating, in response to the target event occurring in the one process, a partition identifier for the one process.

4. The method according to claim 3, wherein updating the partition identifier for the one process includes:
obtaining a first process identifier of the one process;
selecting a first partition identifier from a plurality of partition identifiers, a resource configuration policy corresponding to the first partition identifier corresponding to the resource allocation priority of the one process; and
writing information corresponding to the first process identifier into the first partition identifier.

5. The method according to claim 4, wherein writing the information corresponding to the first process identifier into the first partition identifier includes:
parsing the first process identifier to obtain one or more thread identifiers corresponding to the one process; and
writing the one or more thread identifiers into the first partition identifier.

6. The method according to claim 1, wherein:
the target partition identifier is one of a plurality of partition identifiers configured with different resource assignment policies, respectively, each including a resource partition corresponding to a partition identifier; and
the plurality of partition identifiers include at least two types of partition identifiers corresponding to at least two different resource assignment policies with different resource access priorities.

7. The method according to claim 1, further comprising:
determining that the target event has occurred in the target process in response to the target process being updated from a first process group to a second process group.

8. An electronic device comprising:
a cache including at least one resource partition; and
an allocation component configured to:
obtain, in response to a resource access request of a target process in the electronic device, a target partition identifier corresponding to the target process, the target partition identifier being assigned to the target process in response to a target event occurring in one process, and the target event being related to changes in a resource allocation priority of the one process; and
assign a target resource partition for the target process based on the target partition identifier, the target resource partition being one of the at least one resource partition.

9. The electronic device according to claim 8, further comprising:
a configuration module storing one or more resource configuration policies each including mapping between partition identifiers and resource partitions.

10. The electronic device according to claim 9, wherein the allocation component is further configured to:
assign the target resource partition for the target process according to a resource configuration policy corresponding to the target partition identifier.

11. The electronic device according to claim 10, wherein the allocation component is further configured to:
update, in response to the target event occurring in the one process, a partition identifier for the one process.

12. The electronic device according to claim 11, wherein the allocation component is further configured to, when updating the partition identifier for the one process:
obtain a first process identifier of the one process;
select a first partition identifier from a plurality of partition identifiers, a resource configuration policy corresponding to the first partition identifier corresponding to the resource allocation priority of the one process; and
write information corresponding to the first process identifier into the first partition identifier.

13. The electronic device according to claim 12, wherein the allocation component is further configured to, when writing the information corresponding to the first process identifier into the first partition identifier:
parse the first process identifier to obtain one or more thread identifiers corresponding to the one process; and
write the one or more thread identifiers into the first partition identifier.

14. The electronic device according to claim 8, wherein:
the target partition identifier is one of a plurality of partition identifiers are configured with different resource assignment policies, respectively, each including a resource partition corresponding to a partition identifier; and
the plurality of partition identifiers include at least two types of partition identifiers corresponding to at least two different resource assignment policies with different resource access priorities.

15. The electronic device according to claim 8, wherein the allocation component is further configured to:
determine that the target event has occurred in the target process in response to the target process being updated from a first process group to a second process group.

16. A non-transitory computer-readable storage medium storing instructions that, when executed by a processor, cause an electronic device including the processor to:
obtain, in response to a resource access request of a target process in the electronic device, a target partition identifier corresponding to the target process, the target partition identifier being assigned to the target process in response to a target event occurring in one process, and the target event being related to changes in a resource allocation priority of the one process; and
assign a target resource partition for the target process based on the target partition identifier, the target resource partition being one of a plurality of resource partitions of a cache.

17. The storage medium according to claim 16, wherein the instructions further cause the electronic device to:
assign the target resource partition for the target process according to a resource configuration policy corresponding to the target partition identifier.

18. The storage medium according to claim 17, wherein the instructions further cause the electronic device to:
update, in response to the target event occurring in the one process, a partition identifier for the one process.

19. The storage medium according to claim 18, wherein the instructions further cause the electronic device to, when updating the partition identifier for the one process:
obtain a first process identifier of the one process;
select a first partition identifier from a plurality of partition identifiers, a resource configuration policy corresponding to the first partition identifier corresponding to the resource allocation priority of the one process; and
write information corresponding to the first process identifier into the first partition identifier.

20. The storage medium according to claim 18, wherein the instructions further cause the electronic device to, when writing the information corresponding to the first process identifier into the first partition identifier:
parse the first process identifier to obtain one or more thread identifiers corresponding to the one process; and
write the one or more thread identifiers into the first partition identifier.
